(19) United States
(12) Patent Application Publication
(10) Pub. No.: US 2023/0130233 A1
(43) Pub. Date: Apr. 27, 2023

(54) CONTROLLER, STORAGE DEVICE, AND METHOD OF OPERATING STORAGE DEVICE

(71) Applicant: Samsung Electronics Co., Ltd., Suwon-si (KR)

(72) Inventors: Gyeongmin NAM, Seoul (KR); Chanha KIM, Hwaseong-si (KR); Seungryong JANG, Yangpyeong-gun (KR)

(73) Assignee: Samsung Electronics Co., Ltd., Suwon-si (KR)

(21) Appl. No.: 17/853,195

(22) Filed: Jun. 29, 2022

(30) Foreign Application Priority Data
Oct. 27, 2021 (KR) 10-2021-0144307

(51) Int. Cl. G06F 12/02; G06F 12/06; G06F 12/121

(52) U.S. Cl. CPC G06F 12/0246; G06F 12/0653; G06F 12/121; G06F 2212/7211

(57) ABSTRACT

A method of operating a storage device, including a first memory region having a lowest bit density, a second memory region having a medium bit density, and a third memory region having a highest bit density, includes determining a hotness of a logical address received with a write command and data to be written, from a host, based on the determined hotness being greater than a first hotness threshold, determining whether a wear level of the first memory region is greater than a wear threshold, and increasing the first hotness threshold and storing the data in the second memory region based on the wear level of the first memory region being greater than a threshold.

### CROSS-REFERENCE TO RELATED APPLICATION(S)

This application claims the benefit under 35 USC 119(a) of Korean Patent Application No. 10-2021-0144307 filed on Oct. 27, 2021 in the Korean Intellectual Property Office, the entire disclosure of which is incorporated herein by reference for all purposes.

### BACKGROUND

The present inventive concepts relates to controllers, storage devices, and/or a methods of operating the storage device.

Computer systems may include various types of memory systems, and the memory system includes a memory and a controller. A memory device is used to store data, and is divided into a volatile memory device and a non-volatile memory device. The memory device may include memory regions having different bit densities, and the write speeds and lifetimes of the memory regions may be different from each other.

### SUMMARY

Example embodiments provide configurations and operations related to storage devices separately storing hot data and cold data in memory regions having different bit densities.

Example embodiments provide storage devices in which memory regions are uniformly worn out when data received from a host is stored in memory regions separately under a fluctuating host workload pattern.

According to example embodiments, a method of operating a storage device, including a first memory region having a lowest bit density, a second memory region having a medium bit density, and a third memory region having a highest bit density, includes determining a hotness of a logical address received with a write command and data to be written, from a host; based on the determined hotness being greater than a first hotness threshold, determining whether a wear level of the first memory region is greater than a wear threshold; and increasing the first hotness threshold and storing the data in the second memory region based on the wear level of the first memory region being greater than a threshold.

According to example embodiments, a storage device includes a memory device including memory regions having different bit densities; and a controller controlling the memory device. The controller is configured to determine hotness of data received from a host, determine a target memory region to store the data from among the memory regions according to whether the hotness exceeds a hotness threshold, change the hotness threshold according to a wear level of the target memory region, change the target memory region, and store the data in the changed target memory region.

According to example embodiments, a controller for controlling a memory device including memory regions having different bit densities includes a memory configured to store wearout information of the memory regions; and a processor configured to adjust a hotness threshold, a criterion for classifying and storing data in the memory regions according to hotness of data, based on a wear imbalance between the memory regions being detected based on the wearout information, determine hotness of data received from a host, and provide the data to a selected memory region among the memory regions according to whether the hotness exceeds the hotness threshold.

### BRIEF DESCRIPTION OF DRAWINGS

The above and other aspects, features, and advantages of the present inventive concepts will be more clearly understood from the following detailed description, taken in conjunction with the accompanying drawings, in which:

FIG. 1 is a block diagram illustrating a host-storage system according to some example embodiments;

FIGS. 2 to 5 are diagrams illustrating in detail memory blocks having different properties included in a non-volatile memory;

FIG. 6 illustrates some configurations of a storage device described with reference to FIG. 1;

FIG. 7 is a diagram illustrating an example of a method of determining hotness for each logical address by a storage device;

FIGS. 8 and 9 are flowcharts illustrating an operation of a storage device according to some example embodiments;

FIG. 10 is a block diagram illustrating a host-storage system according to some example embodiments;

FIG. 11 illustrates some configurations of a storage device described with reference to FIG. 10;

FIG. 12 is a flowchart illustrating an operation of a storage device according to some example embodiments;

FIG. 13 is a diagram illustrating an example of a method of determining hotness based on a sector size of a write command by a storage device;

FIGS. 14A to 14B are diagrams illustrating an effect of improving the lifespan of a storage device according to some example embodiments;

FIG. 15 is a cross-sectional view illustrating a memory device according to some example embodiments; and

FIG. 16 is a diagram illustrating a system to which a storage device according to some example embodiments is applied.

### DETAILED DESCRIPTION

Hereinafter, various example embodiments will be described in detail with reference to the accompanying drawings.

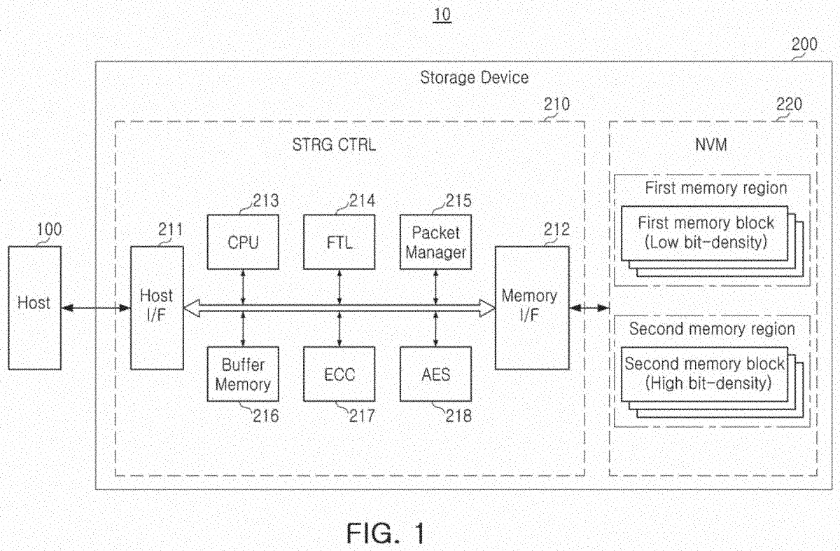

FIG. 1 is a block diagram illustrating a host-storage system according to some example embodiments.

A host-storage system 10 may include a host 100 and a storage device 200. Also, the storage device 200 may include a storage controller 210 and anon-volatile memory (NVM) 220.

The host 100 may include an electronic device such as portable electronic devices such as, for example, cell phones, MP3 players, laptop computers, or electronic devices such as desktop computers, game consoles, TVs, projectors, and the like. The host 100 may include at least one operating system (OS). The operating system may overall manage and control the functions and operations of the host 100.

The storage device 200 may include storage media for storing data according to a request from the host 100. As an example, the storage device 200 may include at least one of a solid state drive (SSD), an embedded memory, and a removable external memory. When the storage device 200 is an SSD, the storage device 200 may be a device conforming to a non-volatile memory express (NVMe) standard. When the storage device 200 is an embedded memory or an external memory, the storage device 200 may be a device conforming to a universal flash storage (UFS) or an embedded multi-media card (eMMC) standard. The host 100 and the storage device 200 may each generate a packet according to an adopted standard protocol and transmit the same.

The non-volatile memory 220 may maintain stored data even when power is not supplied. The nonvolatile memory 220 may store data provided from the host 100 through a programming operation, and may output data stored in the nonvolatile memory 220 through a read operation. The nonvolatile memory 220 may include a plurality of memory blocks, each of which may include a plurality of pages, and each of the pages may include a plurality of memory cells connected to a word line. In some example embodiments, the non-volatile memory 220 may be a flash memory.

When the nonvolatile memory 220 of the storage device 200 includes a flash memory, the flash memory may include a 2D NAND memory array or a 3D (or vertical) NAND (VNAND) memory array. As another example, the storage device 200 may include other various types of non-volatile memories. For example, as the storage device 200, Magnetic Random Access Memory (MRAM), Spin-Transfer Torque MRAM, Conductive bridging RAM (CBRAM), Ferroelectric RAM (FeRAM), Phase RAM (PRAM), Resistive RAM, and various other types of memory may be applied.

The storage controller 210 may include a host interface 211, a memory interface 212, and a central processing unit (CPU) 213. In addition, the storage controller 210 may further include a Flash Translation Layer (FTL) 214, a packet manager 215, a buffer memory 216, an error correction code (ECC) 217 engine, and an advanced encryption standard (AES) 218 engine. The storage controller 210 may further include a working memory (not illustrated) into which the flash translation layer (FTL) 214 is loaded, and data writing and reading operations for the non-volatile memory 220 may be controlled by the CPU 213 executing the flash translation layer 214.

The host interface 211 may transmit and receive packets to and from the host 100. A packet transmitted from the host 100 to the host interface 211 may include a command or data to be written to the non-volatile memory 220, and the like. A packet transmitted from the host interface 211 to the host 100 may include a response to a command or data read from the nonvolatile memory 220.

The memory interface 212 may transmit data to be written to the nonvolatile memory 220 to the nonvolatile memory 220 or receive data read from the nonvolatile memory 220. The memory interface 212 may be implemented to comply with a standard protocol such as a toggle or an Open NAND Flash Interface (ONFI).

The flash translation layer 214 may perform various functions such as address mapping, wear-leveling, and garbage collection. The address mapping operation is an operation of changing a logical address received from the host 100 into a physical address used to actually store data in the nonvolatile memory 220. Wear-leveling is a technique for preventing or reducing excessive deterioration of a specific block by ensuring that blocks in the non-volatile memory 220 are used uniformly, and for example, may be implemented through a firmware technique that balances erase counts of physical blocks. Garbage collection is a technique for securing usable capacity in the non-volatile memory 220 by copying valid data of a block to a new block and then erasing the existing block.

The packet manager 215 may generate a packet according to the protocol of the interface negotiated with the host 100 or parse various types of information from the packet received from the host 100. Also, the buffer memory 216 may temporarily store data to be written to or read from the nonvolatile memory 220. The buffer memory 216 may be provided in the storage controller 210, but may be disposed outside the storage controller 210.

The ECC engine 217 may perform an error detection and correction function on read data read from the nonvolatile memory 220. In detail, the ECC engine 217 may generate parity bits for write data to be written into the non-volatile memory 220, and the generated parity bits may be stored, together with the write data, in the non-volatile memory 220. When reading data from the non-volatile memory 220, the ECC engine 217 corrects an error in the read data, using parity bits read from the non-volatile memory 220 together with the read data, and may output the read data in which errors have been corrected.

The AES engine 218 may perform at least one of an encryption operation and a decryption operation on data input to the storage controller 210 using a symmetric-key algorithm.

The non-volatile memory 220 may include first memory blocks and second memory blocks having different bit densities. A storage area provided by the first memory blocks may be referred to as a first memory region, and a storage area provided by the second memory blocks may be referred to as a second memory region.

The bit density may refer to the number of data bits that one memory cell may store. In the example of FIG. 1, the bit density of the first memory region may be relatively lower than that of the second memory region. For example, the number of bits that may be stored in one memory cell may be relatively smaller in the first memory region than in the second memory region.

The first memory region and the second memory region having different bit densities may have different properties. For example, the second memory region may provide a larger storage capacity than the first memory region in the same area. On the other hand, the first memory region may have a faster access speed and a longer lifespan than the second memory region.

If data having different attributes may be stored separately in memory blocks having different attributes, the nonvolatile memory 220 may be efficiently used. For example, if hot data, which is data that is relatively frequently accessed, is stored in the first memory blocks, the access speed of the hot data may be improved, and the average performance of the storage device 200 may be improved. If cold data, which is data that is relatively infrequently accessed, is stored in the second memory blocks, the data stored in the second memory block may be rarely updated, and deterioration in a lifespan of the second memory blocks may be alleviated.

Whether the data is hot data or cold data may be relatively determined in relation to other data. To determine which data is hot data or cold data, hotness, which is a numerical value indicating a degree of frequent access for each unit data, may be determined. The storage device 200 may provide data received from the host 100 to the first or second memory region according to the hotness of the corresponding data.

On the other hand, the amount of data distributed to each of the first and second memory regions may vary according to the workload pattern of the host 100. Accordingly, the first memory region and the second memory region may be unevenly worn. For example, when a large amount of media data is received from the host 100, the corresponding data may be determined as cold data, and the corresponding data may be intensively (e.g., more often) stored in the second memory region.

If data received from the host 100 is intensively stored in the second memory region, memory blocks of the second memory region may be rapidly worn out compared to memory blocks of the first memory region. If the memory regions are unevenly worn, some memory blocks may expire earlier than other memory blocks, and it may be difficult to normally use the storage device 200 even if the lifespans of other memory blocks remain.

According to some example embodiments of the present inventive concepts, the storage device 200 may dynamically adjust a criterion for classifying data into hot data and cold data based on wear levels of memory regions. When the criterion for classifying data is adjusted, the amount of data provided to each memory region may be adjusted, and as a result, the memory regions may be evenly worn. Accordingly, the lifespan of the storage device 200 may be improved.

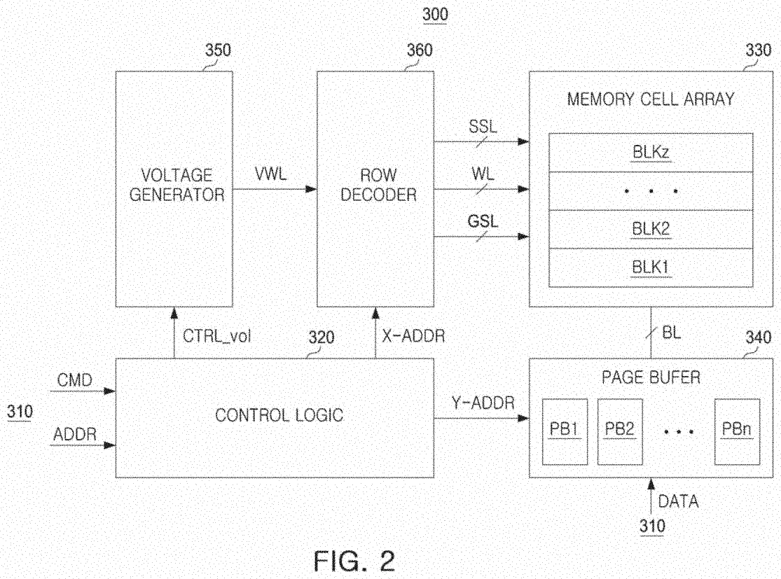

Hereinafter, before describing the operation of the storage device 200 according to some example embodiments of the present inventive concepts, memory blocks having different properties included in the nonvolatile memory 220 will be described in more detail with reference to FIGS. 2 to 5.

FIG. 2 is an illustrative block diagram illustrating a memory device. Referring to FIG. 2, a memory device 300 may include a control logic circuit 320, a memory cell array 330, a page buffer 340, a voltage generator 350, and a row decoder 360. Although not illustrated in FIG. 2, the memory device 300 may further include a memory interface circuit 310 illustrated in FIG. 2, and may further include column logic, a pre-decoder, a temperature sensor, a command decoder, an address decoder, and the like.

The control logic circuit 320 may overall control various operations in the memory device 300. The control logic circuit 320 may output various control signals in response to a command CMD and/or an address ADDR from the memory interface circuit 310. For example, the control logic circuit 320 may output a voltage control signal CTRL vol, a row address X-ADDR, and a column address Y-ADDR.

The memory cell array 330 may include a plurality of memory blocks BLK1 to BLKz (z is a positive integer), and each of the plurality of memory blocks BLK1 to BLKz may include a plurality of memory cells. The memory cell array 330 may be connected to the page buffer unit 340 through bit lines BL, and may be connected to the row decoder 360 through word lines WL, string select lines SSL, and ground select lines GSL.

In some example embodiments, the memory cell array 330 may include a three-dimensional (3D) memory cell array, and the 3D memory cell array may include a plurality of NAND strings. Each NAND string may include memory cells respectively connected to word lines stacked vertically on the substrate. U.S. Pat. Nos. 7,679,133, 8,553,466, 8,654,587, 8,559,235, and U.S. Patent Application Publication No. 2011/0233648 are incorporated herein by reference. In some example embodiments, the memory cell array 330 may include a two-dimensional memory cell array, and the two-dimensional memory cell array may include a plurality of NAND strings disposed in row and column directions.

The page buffer 340 may include a plurality of page buffers PB1 to PBn (n is an integer greater than or equal to 3), and the plurality of page buffers PB1 to PBn may be respectively connected to memory cells through a plurality of bit lines BL. The page buffer 340 may select at least one bit line among the bit lines BL in response to the column address Y-ADDR. The page buffer 340 may operate as a write driver or a sense amplifier according to an operation mode. For example, during a programming operation, the page buffer 340 may apply a bit line voltage corresponding to data to be programmed to a selected bit line. During a read operation, the page buffer 340 may sense the data stored in the memory cell by sensing the current or voltage of the selected bit line.

The voltage generator 350 may generate various types of voltages for performing program, read, and erase operations based on the voltage control signal CTRL vol. For example, the voltage generator 350 may generate a program voltage, a read voltage, a program verify voltage, an erase voltage, and the like, as the word line voltage VWL.

The row decoder 360 may select one of the plurality of word lines WL in response to the row address X-ADDR and may select one of the plurality of string select lines SSL. For example, during a programming operation, the row decoder 360 may apply a program voltage and a program verify voltage to a selected word line, and during a read operation, apply a read voltage to the selected word line.

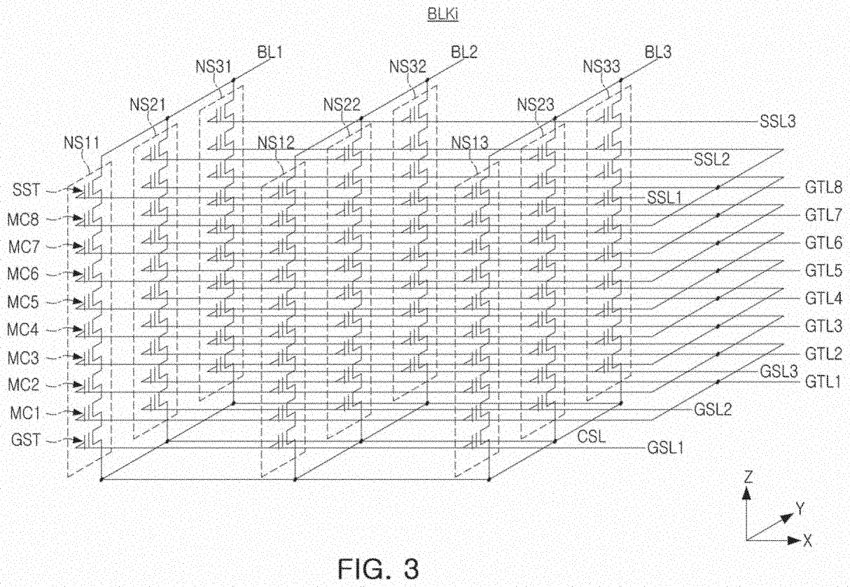

FIG. 3 is a diagram illustrating a 3D V-NAND structure applicable to a storage device according to some example embodiments of the present inventive concepts. When the nonvolatile memory of the storage device is implemented as a 3D V-NAND type flash memory, each of a plurality of memory blocks constituting the nonvolatile memory may be represented by an equivalent circuit as illustrated in FIG. 3.

The memory block BLKi illustrated in FIG. 3 represents a three-dimensional memory block formed on a substrate in a three-dimensional structure. For example, a plurality of memory NAND strings included in the memory block BLKi may be formed in a direction perpendicular to the substrate.

Referring to FIG. 3, the memory block BLKi may include a plurality of memory NAND strings NS11 to NS33 connected between the bit lines BL1, BL2, and BL3 and the common source line CSL. Each of the plurality of memory NAND strings NS11 to NS33 may include a string select transistor SST, a plurality of memory cells MC1, MC2, . . . , and MC8, and a ground select transistor GST. Although it is illustrated in FIG. 3 that each of the plurality of memory NAND strings NS11 to NS33 includes eight memory cells MC1, MC2, . . . , and MC8, the present inventive concepts are not limited thereto.

The string select transistor SST may be connected to the corresponding string select line SSL1, SSL2, SSL3. The plurality of memory cells MC1, MC2, . . . , and MC8 may be respectively connected to corresponding gate lines GTL1, GTL2, . . . , and GTL8. The gate lines GTL1, GTL2, . . . , and GTL8 may correspond to word lines, and a portion of the gate lines GTL1, GTL2, . . . , and GTL8 may correspond to a dummy word line. The ground select transistor GST may be connected to the corresponding ground select line GSL1, GSL2, GSL3. The string select transistor SST may be connected to the corresponding bit lines BL1, BL2, and BL3, and the ground select transistor GST may be connected to the common source line CSL.

Word lines of the same height (e.g., WL1) may be connected in common, and the ground select lines GSL1, GSL2, and GSL3 and the string select lines SSL1, SSL2, and SSL3 may be separated from each other, respectively. FGIG. 3 illustrates that the memory block BLK is connected to eight gate lines GTL1, GTL2, . . . , and GTL8 and three bit lines BL1, BL2, BL3, but the configuration is not limited thereto.

The memory block BLKi may have different bit densities according to the number of bits stored by the memory cells included in the memory block BLKi.

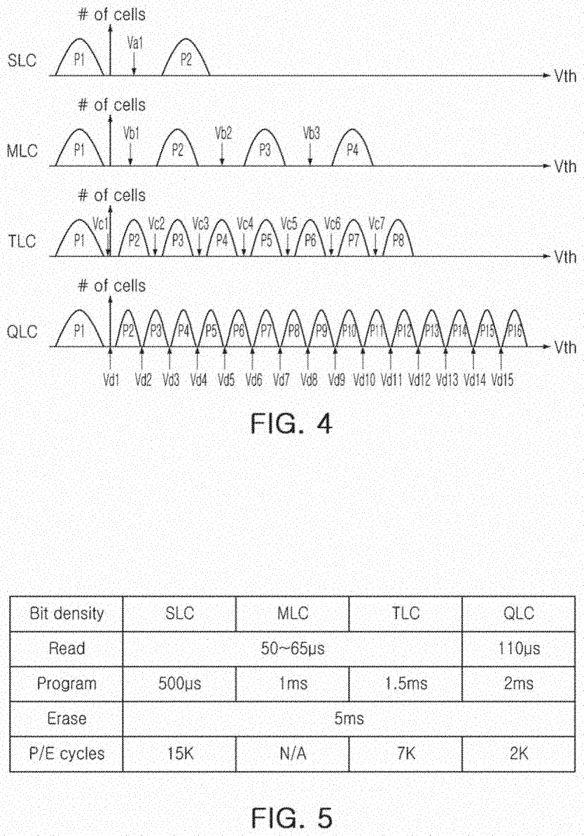

FIG. 4 is a diagram illustrating threshold voltage distributions according to the number of bits stored in a memory cell.

Referring to FIG. 4, the horizontal axis of each graph indicates the threshold voltage level, and the vertical axis indicates the number of memory cells.

When the memory cell is a single level cell (SLC) that stores 1-bit data, the memory cell may have a threshold voltage corresponding to any one of a first program state P1 and a second program state P2. The read voltage Va1 may be a voltage for distinguishing the first program state P1 and the second program state P2. The memory cell having the first program state P1 has a lower threshold voltage than the read voltage Va1, and thus, may be read as an on-cell. The memory cell having the second program state P2 has a higher threshold voltage than the read voltage Va1, and thus, may be read as an off cell.

When the memory cell is a multiple level cell (MLC) that stores 2-bit data, the memory cell may have a threshold voltage corresponding to any one of the first to fourth program states P1 to P4. First to third read voltages Vb1 to Vb3 may be read voltages for distinguishing the first to fourth program states P1 to P4 respectively. The first read voltage Vb1 may be a read voltage for distinguishing the first program state P1 and the second program state P2. The second read voltage Vb2 may be a read voltage for distinguishing the second program state P2 and the third program state P3. The third read voltage Vb3 may be a read voltage for distinguishing the third program state P3 and the fourth program state P4.

When the memory cell is a triple level cell (TLC) that stores 3-bit data, the memory cell may have a threshold voltage corresponding to any one of the first to eighth program states P1 to P8. The first to seventh read voltages Vc1 to Vc7 may be read voltages for distinguishing each of the first to eighth program states P1 to P8. The first read voltage Vc1 may be a read voltage for distinguishing the first program state P1 and the second program state P2. The second read voltage Vc2 may be a read voltage for distinguishing the second program state P2 and the third program state P3. In the same manner, the seventh read voltage Vc7 may be a read voltage for discriminating the seventh program state P7 and the eighth program state P8.

When the memory cell is a quadruple level cell (QLC) that stores 4-bit data, the memory cell may have any one of the first to sixteenth program states P1 to P16. The first to fifteenth read voltages Vd1 to Vd15 may be read voltages for distinguishing each of the first to sixteenth program states P1 to P16. The first read voltage Vd1 may be a read voltage for distinguishing the first program state P1 and the second program state P2. The second read voltage Vd2 may be a read voltage for distinguishing the second program state P2 and the third program state P3. In the same manner, the fifteenth read voltage Vd15 may be a read voltage for distinguishing the fifteenth program state P15 and the sixteenth program state P16.

The properties of the memory regions may vary according to bit densities of memory cells included in the memory regions. FIG. 5 illustrates attribute values of memory regions according to bit densities. In detail, FIG. 5 illustrates read, program, and erase operation times and limit Program/Erase (P/E) cycles specified in a specification according to bit densities of memory regions.

In the example of FIG. 5, a read operation time and a programming operation time of the QLC memory region may be longest. In addition, the program time of the SLC memory region may be the shortest. As a memory block has a higher bit density, the number of program states formed in memory cells of the corresponding memory block and the number of read voltages for distinguishing each program state may increase. Accordingly, the higher the bit density of the memory block is, the longer the programming operation time for forming each program state is and the longer the read operation time for distinguishing each program state is, and thus, the lower the access speed may be.

In the example of FIG. 5, the limit P/E cycle of the QLC memory region may be the fewest, and the limit P/E cycle of the SLC memory region may be the most. The P/E cycle may refer to the number of program and erase operations that occur whenever data is stored in a memory cell. In addition, the limit P/E cycle may refer to a maximum P/E cycle until the lifespan of the memory cell is terminated. If program and erase operations are repeated in the memory cell, the memory cell may deteriorate. When the memory cell is deteriorated, it may be difficult to precisely program each program state of the memory cells. Memory cells with higher bit densities require more sophisticated programming of the program state, and thus, memory cells with higher bit densities may reach their end of lifespan in fewer P/E cycles.

When the storage device divides and stores data in memory regions having different bit densities based on the hotness of the data, and thus, data may be evenly distributed to each memory region, the lifespan of the storage device may be improved. According to some example embodiments, the storage device may change the hotness threshold, which is a criterion for classifying data in the memory regions and storing the data, based on the current wear level of the memory regions. According to some example embodiments, even in the case in which the host workload pattern changes, data may be evenly distributed to each memory region, memory regions are worn evenly, and the lifespan of the storage device may be improved.

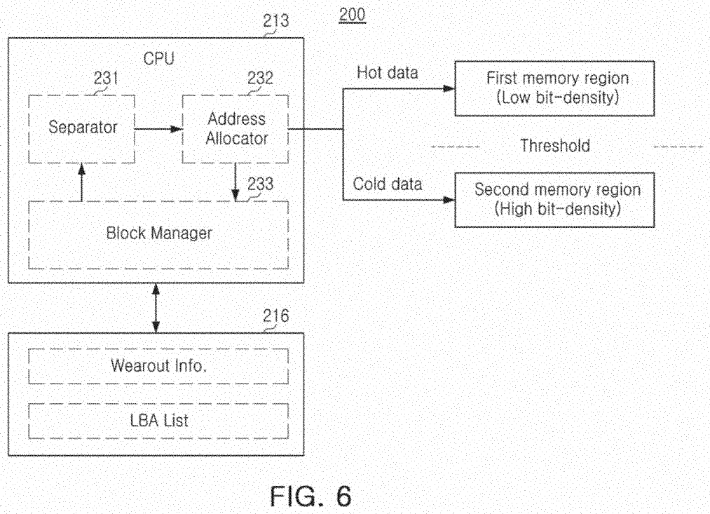

Hereinafter, a storage device and an operating method thereof according to some example embodiments will be described with reference to FIGS. 6 to 10.

FIG. 6 illustrates some configurations of the storage device 200 described with reference to FIG. 1. For example, the CPU 213, the buffer memory 216, the first memory region, and the second memory region of FIG. 6 may correspond to those described with reference to FIG. 1.

The first memory region may be a memory region having a relatively low bit density, and the second memory region may be a memory region having a relatively high bit density. For example, the first memory region may be an SLC memory region, and the second memory region may be a TLC memory region or a QLC memory region, but is not limited thereto.

The CPU 213 may drive a separator 231, an address allocator 232, and a block manager 233. The separator 231, the address allocator 232, and the block manager 233 may be loaded into a working memory (not illustrated) and driven by the CPU 213. For example, the separator 231, the address allocator 232, and the block manager 233 may be included in the flash translation layer 214 described with reference to FIG. 1.

The separator 231 may determine an attribute of data received from the host 100. For example, the separator 231 may determine the hotness of data received from the host 100 and determine whether the data is hot data or cold data based on the hotness. For example, the separator 231 may determine data having a hotness greater than a threshold value, as hot data, and determine data having a hotness equal to or less than a threshold value, as cold data.

The address allocator 232 may map a logical address received from the host 100 to a physical address of the nonvolatile memory 220. For example, the logical address may be a logical block address (LBA) used in the file system of the host 100. The address allocator 232 may perform address mapping so that data classified as hot data by the separator 231 is stored in a first memory region and data classified as cold data is stored in a second memory region.

The block manager 233 may manage memory blocks included in the nonvolatile memory 220. For example, the block manager 233 may determine a wear level for each memory region by counting P/E cycles for each memory block. For example, the block manager 233 may determine the degree of wear of the memory region, based on the limit P/E cycle compared to the current P/E cycle of each memory region.

The buffer memory 216 may store data necessary for the operation of the storage device 200. For example, the buffer memory 216 may store wearout information (Wearout Info.) and a logical block address list (LBA list). The wearout information may include information for the block manager 233 to determine the wear level for each memory region, for example, a P/E cycle for each memory block. In addition, the logical address list is information necessary for the separator 231 to determine the hotness of data, and may include logical addresses recently received from the host.

According to some example embodiments, the separator 231 may adjust the hotness threshold based on the degree of wear for each memory region obtained from the block manager 233. For example, when it is determined that the wear level of the first memory region is higher than that of the entire nonvolatile memory 220, the separator 231 may increase the hotness threshold to reduce the amount of data classified as hot data, and as a result, the amount of data provided to the first memory region may be reduced.

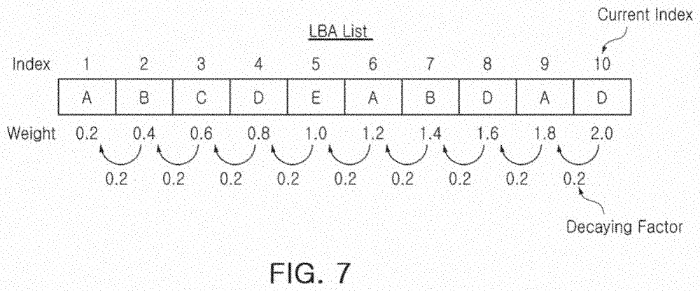

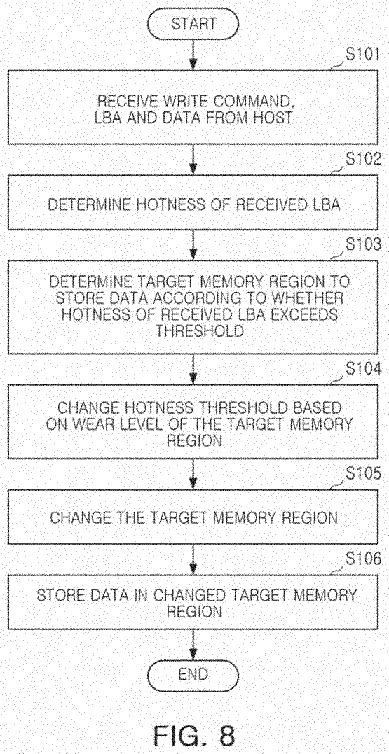

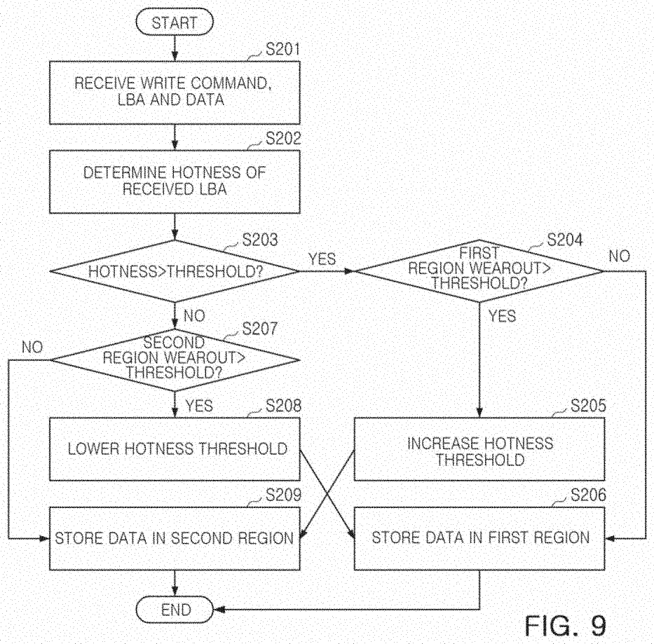

Hereinafter, an example of a method for a storage device to determine hotness will be described with reference to FIG. 7, and a method for a storage device to adjust a hotness threshold based on wear levels for each memory region may be described in detail with reference to FIGS. 8 to 9.

FIG. 7 is a diagram illustrating an example of a method in which a storage device determines hotness based on a reception frequency and recency for each logical address.

FIG. 7 illustrates a logical address list including a fixed number of entries. The logical address list may store a predetermined (e.g., desired) number of recently received logical addresses. In the example of FIG. 7, the logical address list may include 10 entries. The symbols A, B, C, D, and E indicated in the entries of the logical address list represent different logical addresses. The index indicated above the entries indicates the order in which logical addresses were received from the host. For example, the first received logical address may be ‘A’, and the tenth received logical address may be ‘D’.

Depending on the implementation, the logical address list may be stored in the buffer memory 216. The separator 231 may determine hotness for each logical address by referring to the logical address list. For example, the separator 231 may determine hotness for each logical address by counting the number of each of logical addresses A, B, C, D, and E in the logical address list. To reflect the recency of the logical address in the hotness of the logical address, when the separator 231 inserts the latest logical address into the logical address list, the separator 231 may give a highest weight to the latest logical address and may reduce the weight of existing logical addresses stored in the logical address list. FIG. 7 illustrates a case in which the latest logical address has the highest weight of 2.0, the weight of the existing logical addresses is monotonically decreased by 0.2 each time a logical address is received, and thus, as the order in which the logical addresses were received is relatively older, the lower the weight of the logical addresses is.

The separator 231 may receive data to be written and a logical address corresponding to the data, along with a write command, from the host 100. The separator 231 may determine the hotness of the logical address by referring to the logical address list, and may determine the data as hot data or cold data based on the determined hotness. For example, upon receiving the latest logical address D from the host 100, the separator 231 may insert the latest logical address D into the tenth entry of the logical address list. The separator 231 may determine the hotness of the latest logical address D by summing all weights for the logical address D stored in the logical address list. In the example of FIG. 7, the hotness of the latest logical address D may be determined to be 4.4 (=0.8+1.6+2.0). For example, when the hotness threshold for classifying data into hot data or cold data is 4.0, the separator 231 may determine the data corresponding to the logical address D as hot data, based on the fact that the hotness of the logical address D is greater than the hotness threshold. For example, when the hotness threshold is adjusted to 5.0, the separator 231 may determine that the hotness of the logical address D is equal to or less than the hotness threshold, and may determine that data corresponding to the logical address D is cold data.

According to some example embodiments, the hotness threshold may be adjusted based on wear levels of memory regions. Hereinafter, the method of adjusting the hotness threshold by the storage device is described in detail.

FIG. 8 is a flowchart illustrating an operation of a storage device according to some example embodiments.

In operation S101, the storage device may receive a write command, data to be written, and a logical address corresponding to the data from the host. The logical address received in operation S101 may be referred to as the latest logical address.

In operation S102, the storage device may determine the hotness of the latest logical address. An example of the method of determining the hotness of the latest logical address by the storage device is described above with reference to FIG. 7. On the other hand, FIG. 7 illustrates an example of a method of searching for recently received logical addresses using a logical address list to determine the hotness of the latest logical address, and determining the hotness of the latest logical address based on the found logical addresses. However, the present inventive concepts are not limited thereto, and a hash function, a bloom filter, or the like may be used instead of a logical address list, to search for recently received logical addresses.

In operation S103, the storage device may determine a memory region to store data according to whether the hotness of the latest logical address exceeds the hotness threshold.

For example, the storage device may determine to store the data in the first memory region when the hotness of the latest logical address is greater than the hotness threshold, and may determine to store data in the second memory region when the hotness of the latest logical address is equal to or less than the hotness threshold. Hereinafter, a memory region to store data is referred to as a target memory region.

In operation S104, the storage device may change the hotness threshold based on the wear level of the target memory region.

The wear level of the target memory region may be determined based on P/E cycles of memory blocks included in the corresponding memory region and limit P/E cycles of the memory blocks.

For example, a first memory region storing hot data may be determined as a target memory region. When the wear level of the first memory region is greater than the average wear level of the entire nonvolatile memory, the storage device may increase the hotness threshold to mitigate the increase in the wear level of the first memory region. When the hotness threshold is increased, the amount of data determined as hot data may decrease and the amount of data provided to the first memory region may decrease. Therefore, an increase in wear of the first memory region may be alleviated.

In operation S105, when the hotness threshold is changed, the storage device may change the target memory region to store data.

For example, when it is determined that the wear of the first memory region is greater than the wear of the entire non-volatile memory, and the hotness threshold is thus increased, the storage device may determine to store data received from the host in the second memory region to alleviate an increase in the wear level of the first memory region.

In operation S106, the storage device may store data in the changed target memory region.

According to some example embodiments, by adjusting a hotness threshold for classifying data attributes based on the degree of wear of memory regions, the memory regions may be reduced or prevented from being unevenly worn. Accordingly, the lifespan of the storage device may be improved.

FIG. 9 is a flowchart illustrating in detail a method of operating a storage device according to some example embodiments.

Operations S201 and S202 may be the same as operations S101 and S102 described with reference to FIG. 8.

In operation S203, the storage device may determine whether the hotness of the received logical address is greater than a hotness threshold.

When the hotness of the logical address is greater than the hotness threshold (“Yes” in operation S203), the storage device may determine that the data received from the host is hot data, and may determine a target memory region in which the data is to be stored as a first memory region. Then, the storage device may determine whether the wear level of the first memory region is greater than the wear threshold in operation S204.

The wear threshold may be a criterion for determining whether the wear level of the memory region is higher than the overall wear level of the nonvolatile memory. For example, the wear threshold may be determined as an average wear level of memory regions included in the nonvolatile memory. The average wear may increase over time, and the wear threshold may also increase over time. On the other hand, determining the wear threshold is not limited to determining based on the average wear level of the memory regions.

When the wear level of the first memory region is greater than the wear threshold (“Yes” in operation S204), the storage device may increase the hotness threshold in operation S205. By increasing the hotness threshold, the storage device may reduce the amount of data classified as hot data, alleviate an increase in wear of the first memory region, and eliminate uneven wear between the first memory region and the second memory region. Then, in operation S209, the storage device may store data from the host in the second memory region instead of the first memory region, and end the operation.

When the wear level of the first memory region is equal to or less than the wear threshold (“No” in operation S204), the storage device may not change the hotness threshold, and may store data from the host in the first memory region that is the original target memory region, in operation S206, and the operation may be terminated.

When the hotness of the logical address is less than or equal to the hotness threshold (“No” in operation S203), the storage device may determine that the data received from the host is cold data, and may determine the target memory region in which the data is to be stored, as the second memory region.

In operation S207, the storage device may determine whether the wear level of the second memory region is greater than the wear threshold.

When the wear level of the second memory region is greater than the wear threshold (“Yes” in operation S207), the storage device may lower the hotness threshold in operation S208. The storage device may increase the amount of data classified as hot data and decrease the amount of data classified as cold data by lowering the hotness threshold. When the amount of data classified as cold data is reduced, an increase in the wear level of the second memory region may be alleviated, and uneven wear between the first memory region and the second memory region may be resolved. In operation S206, the storage device may store data from the host in the first memory region instead of the second memory region, and end the operation.

When the wear level of the second memory region is equal to or less than the wear threshold (“No” in operation S207), the storage device may store the data from the host in the second memory region that is the original target memory region in operation S209, and the operation may be terminated.

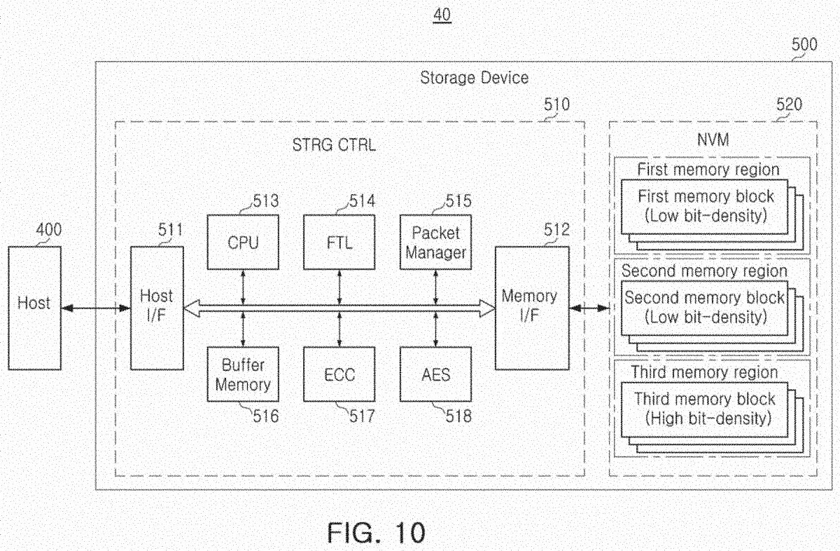

Some example embodiments have been described with reference to FIGS. 6 to 9, taking as an example a case in which a storage device includes two memory regions having different bit densities. However, the present inventive concepts are not limited thereto. For example, the present inventive concepts may also be applied to a case in which a storage device includes three or more memory regions having different bit densities. Hereinafter, an example of a storage device including three or more memory regions and an operating method thereof will be described with reference to FIGS. 10 to 12.

FIG. 10 is a block diagram illustrating a host-storage system 40 according to some example embodiments.

The host-storage system 40 may include a host 400 and a storage device 500. Also, the storage device 500 may include a storage controller 510 and a non-volatile memory (NVM) 520.

The host 400 may include an operating system that overall manages and controls functions and operations of the host 400, similarly to the host 100 described with reference to FIG. 1. Also, similar to the storage device 200 described with reference to FIG. 1, the storage device 500 may include storage media for storing data according to a request from the host 400.

The storage controller 510 may include a host interface 511, a memory interface 512, and a CPU 513. In addition, the storage controller 510 may further include a flash translation layer 514, a packet manager 515, a buffer memory 516, an ECC engine 517, and an AES engine 518. Components included in the storage controller 510 may operate similarly to those included in the storage controller 210 described with reference to FIG. 1.

The non-volatile memory 520 may retain stored data even when power is not supplied. The nonvolatile memory 520 may store data provided from the host 400 through a programming operation, and may output data stored in the nonvolatile memory 520 through a read operation. The non-volatile memory 520 includes a plurality of memory blocks, each of the memory blocks includes a plurality of pages, and each of the pages may include a plurality of memory cells connected to a word line.

The non-volatile memory 520 may include first to third memory regions having different bit densities. In detail, the first memory region may have a lowest bit density, the second memory region may have a medium bit density, and the third memory region may have a highest bit density. For example, the first memory region may be an SLC memory region, the second memory region may be a TLC memory region, and the third memory region may be a QLC memory region.

The storage controller 510 may classify data from the host 400 into hot data, warm data, and cold data according to hotness, and may store the data in first to third memory regions, respectively. The amount of data provided to the first to third memory regions may vary according to the workload pattern of the host 400, and the first to third memory regions may be unevenly worn.

According to some example embodiments of the present inventive concepts, the storage device 500 may alleviate uneven wear of memory regions by dynamically adjusting a criterion for classifying data into hot data, warm data, and cold data, based on the wear level of the memory regions.

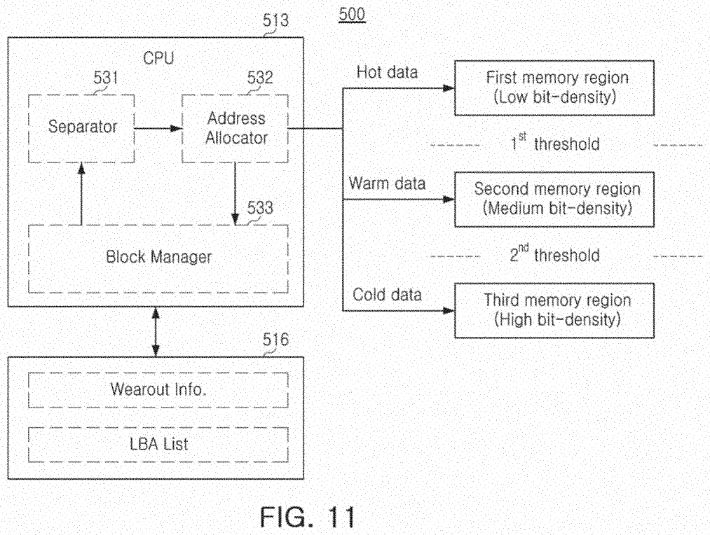

FIG. 11 illustrates some configurations of the storage device 500 described with reference to FIG. 10. For example, the CPU 513 and the first to third memory regions of FIG. 11 may correspond to those described with reference to FIG. 10.

The CPU 513 may drive a separator 531, an address allocator 532, and a block manager 533. For example, the separator 531, the address allocator 532, and the block manager 533 may be loaded into a working memory (not illustrated) and driven in the CPU 513.

The separator 531 may determine whether data corresponding to the logical address is hot data, warm data, or cold data based on the hotness of the logical address. For example, the separator 531 may determine the data as hot data when the hotness of the logical address is greater than a first threshold, determine the data as warm data when the hotness is equal to or less than the first threshold and greater than a second threshold, and determine the data as cold data when the hotness is less than or equal to the second threshold.

The address allocator 532 may map a logical address to a physical address of the nonvolatile memory 520. For example, the address allocator 532 may map a logical address to a physical address, such that hot data is stored in the first memory region, warm data is stored in the second memory region, and cold data is stored in the third memory region.

The block manager 533 may manage memory blocks included in the nonvolatile memory 520. For example, the block manager 533 may determine the wear level for each memory region by performing an erase count for each memory block.

The buffer memory 516 may store data required for the operation of the storage device 500. For example, the buffer memory 516 may store wearout information and a logical block address list (LBA list). The wearout information and the logical address list may be the same as those described with reference to FIG. 6.

According to some example embodiments, the separator 531 adjusts the amount of data distributed to the memory regions by adjusting the hotness threshold based on the wear level for each memory region obtained from the block manager 533, and the memory region may be worn evenly. Accordingly, the lifespan of the storage device 500 may be improved.

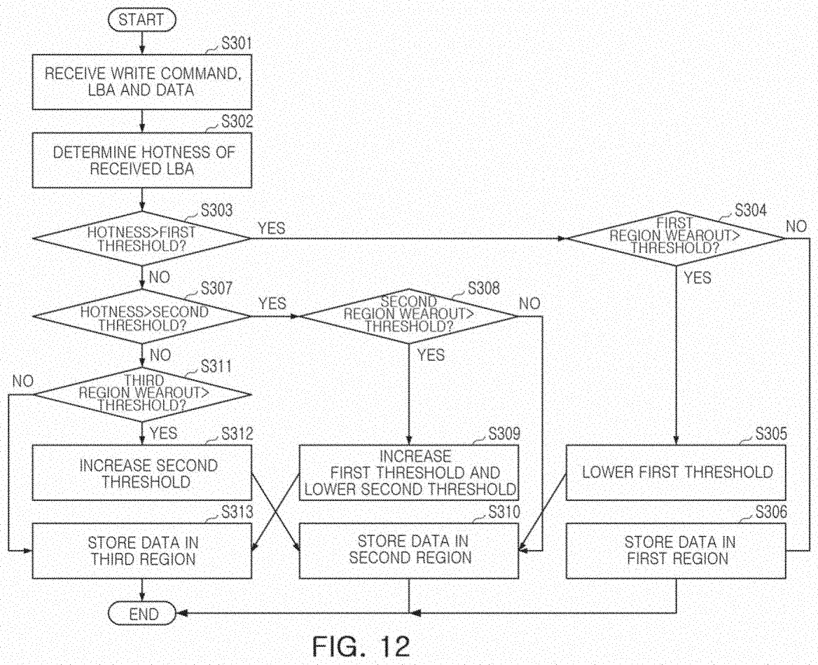

FIG. 12 is a flowchart illustrating an operation of a storage device according to some example embodiments.

In operation S301, the storage device may receive a write command, a logical address, and data to be written from the host.

In operation S302, the storage device may determine the hotness of the received logical address. For example, the storage device may determine the hotness of the logical address in the same manner as described with reference to FIG. 7.

In operation S303, the storage device may determine whether the hotness of the logical address is greater than a first hotness threshold.

When the hotness of the logical address is greater than the first hotness threshold (“Yes” in operation S303), the storage device may determine that the data received from the host is hot data, and determine a target memory region in which the data is to be stored, as the first memory region. Then, the storage device may determine whether the wear level of the first memory region is greater than a wear threshold, for example, the average wear level of the memory regions in operation S304.

When the wear level of the first memory region is greater than the wear threshold (“Yes” in operation S304), the storage device may increase the first hotness threshold in operation S304. The storage device may reduce the amount of data classified as hot data by increasing the first hotness threshold. When the amount of hot data is reduced, an increase in the wear level of the first memory region may be alleviated, and uneven wear between the memory regions may be resolved. Then, in operation S310, the storage device may store data from the host in the second memory region instead of the first memory region, and end the operation.

When the wear level of the first memory region is equal to or less than the wear threshold (“No” in operation S304), the storage device does not change the hotness threshold, and in operation S306, may store data from the host in the first memory region that is the original target memory region, and the operation may be terminated.

When the hotness of the logical address is less than or equal to the first hotness threshold (“No” in operation S303), the storage device may determine in operation S307 whether the hotness of the logical address is greater than a second hotness threshold.

When the hotness of the logical address is greater than the second hotness threshold (“Yes” in operation S307), the storage device may determine that the data received from the host is warm data and determine a target memory region in which the data is to be stored, as the second memory region. Then, the storage device may determine whether the wear level of the second memory region is greater than the wear threshold in operation S308.

When the wear level of the second memory region is greater than the wear threshold (“Yes” in operation S308), the storage device lowers the first hotness threshold and increases the second hotness threshold to reduce the amount of data classified as the warm data in operation S309. When the amount of warm data is reduced, an increase in wear of the second memory region may be alleviated, and uneven wear between the memory regions may be resolved. Then, in operation S313, the storage device may store data from the host in the third memory region instead of the second memory region, and end the operation.

When the wear level of the second memory region is less than or equal to the wear threshold (“No” in operation S308), the storage device does not change the hotness threshold, and in operation 5310, may store data from the host in the second memory region that is the original target memory region and may end the operation.

When the hotness of the logical address is less than or equal to the second hotness threshold (“No” in operation S307), the storage device may determine that the data received from the host is cold data, and may determine the target memory region in which the data is to be stored, as the third memory region. Then, the storage device may determine whether the wear level of the third memory region is greater than the wear threshold in operation 5311.

When the wear level of the third memory region is greater than the wear threshold (“Yes” in operation S311), the storage device may reduce the amount of data classified as cold data by lowering the second hotness threshold in operation 5312. When the amount of cold data is reduced, an increase in wear of the third memory region may be alleviated, and uneven wear between the memory regions may be resolved. Then, the storage device may store data from the host in the second memory region instead of the third memory region in operation S310, and end the operation.

When the wear level of the third memory region is equal to or less than the wear threshold (“No” in operation S311), the storage device does not change the hotness threshold, and may store data from the host in the third memory region that is the original target memory region in operation 5313, and the operation may be terminated.

According to some example embodiments, the storage device may equalize the wear level of the memory regions and improve the lifespan of the storage device by dynamically changing the hotness threshold based on the wear level of the memory regions.

On the other hand, some example embodiments have been described with reference to FIGS. 7 to 12, taking the case in which the storage device determines hotness based on the reception frequency and recency for each logical address as an example. However, the present inventive concepts are not limited thereto.

For example, the storage device may classify data into hot data, warm data, and cold data according to whether the sector size of the write command exceeds a threshold value. In addition, the storage device may adjust the threshold value based on wear levels of memory regions having different bit densities.

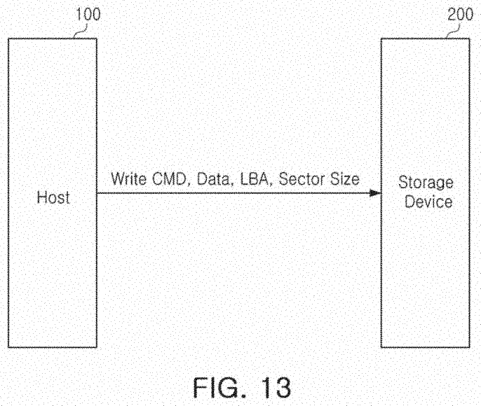

FIG. 13 is a diagram illustrating an example of a method for a storage device to determine hotness based on a sector size of a write command.

The host 100 may provide data, a logical address of the data, and a sector size of the data together while providing the write command to the storage device 200.

According to an implementation, hotness of data may be determined based on a sector size of the data. Data having a relatively small sector size may be data with a relatively high possibility of being accessed frequently, mainly such as system data, and data having a large sector size may be data having a low probability of being accessed frequently, mainly such as media data. For example, it is known that data received with a 4K write command, for example, a write command having a sector size of 4 KB, is mostly hot data.

Accordingly, the separator 231 may classify data into hot data, warm data, and cold data according to whether a sector size received together with a write command received from the host 100 exceeds a predetermined (e.g., desired) hotness threshold. For example, the separator 231 may classify the data as hot data when the sector size is 4 KB or less, classify the data as warm data when the sector size is greater than 4 KB and less than or equal to 8 KB, and classify the data as cold data when the sector size is greater than 8 KB.

According to some example embodiments, a target memory region to store data may be determined from among first to third memory regions having different bit densities according to whether a sector size of received data exceeds a threshold value, and the hotness threshold may be adjusted according to the wear level of the target memory region.

For example, when data having a sector size of 16 KB is received, the separator may determine the data as cold data, and the address allocator may determine a third memory region, which is a memory region having the highest bit density, as the target memory region. When the wear level of the third memory region exceeds a threshold value, the separator may adjust the hotness threshold ‘8 KB’ for classifying warm data and cold data, for example, to ‘12 KB’, such that the amount of data provided to the third memory region is reduced.

For example, according to some example embodiments, even when the storage device determines the hotness of data based on the sector size, the wear level of the memory regions may be equalized by dynamically changing the hotness threshold based on the wear level of the memory regions, thereby improving the lifespan of the storage device.

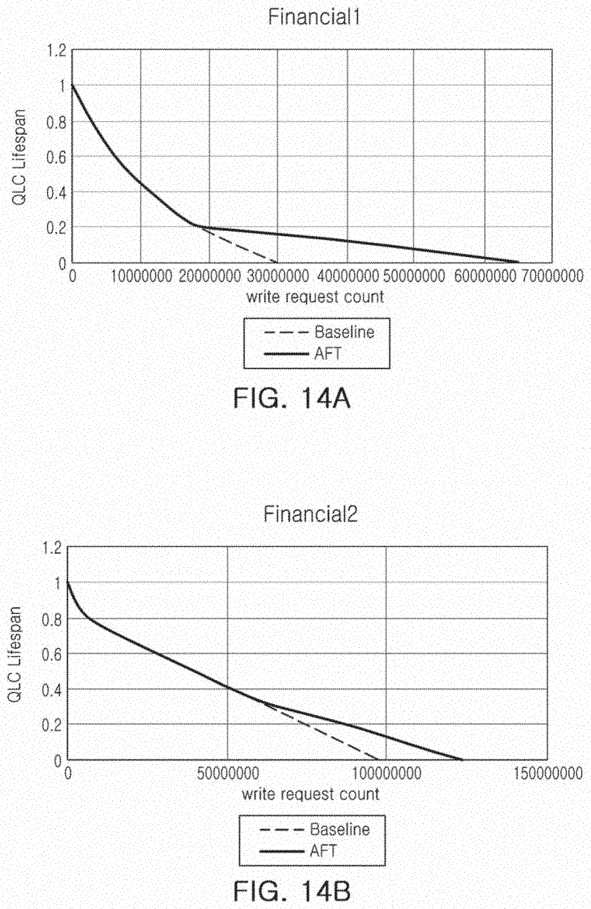

FIGS. 14A and 14B are diagrams illustrating an effect of improving the lifespan of a storage device according to some example embodiments of the present inventive concepts.

FIG. 14A illustrates a decrease in the remaining lifespan of a QLC memory region according to a test using Financial1, which is a test workload pattern.

The horizontal axis of the graph of FIG. 13A indicates the number of times a write request is received from the host, and the vertical axis indicates the remaining lifespan of the QLC memory region according to the number of write requests. The remaining lifespan of the memory region may be determined based on the remaining P/E cycles and the limit P/E cycles of the corresponding memory region. The remaining P/E cycle may be determined according to the limit P/E cycle and the current P/E cycle.

In FIG. 14A, ‘AFT’ indicates the remaining lifespan of the QLC memory region when the hotness threshold is dynamically adjusted according to some example embodiments, and ‘Baseline’ represents the remaining lifespan of the QLC memory region when the hotness threshold is fixed according to a comparative example different from the example embodiment of the present inventive concepts. According to the comparative example, the lifespan of the QLC memory region may be terminated after 30 million write requests are processed because it is difficult to resolve the imbalance of wear levels for respective memory regions. Meanwhile, according to some example embodiments of the present inventive concepts, since memory regions may be uniformly worn, the lifespan of the storage device may be improved to the extent that the storage device may process 60 million or more write requests.

FIG. 14B illustrates the trend of decreasing the remaining lifespan of the QLC memory region according to the test using Financial2, which is a test workload pattern.

Similar to that described with reference to FIG. 14A, the lifespan of the storage device may be improved when the hotness threshold is dynamically adjusted according to some example embodiments of the present inventive concepts, rather than when the hotness threshold is fixed according to the comparative example.

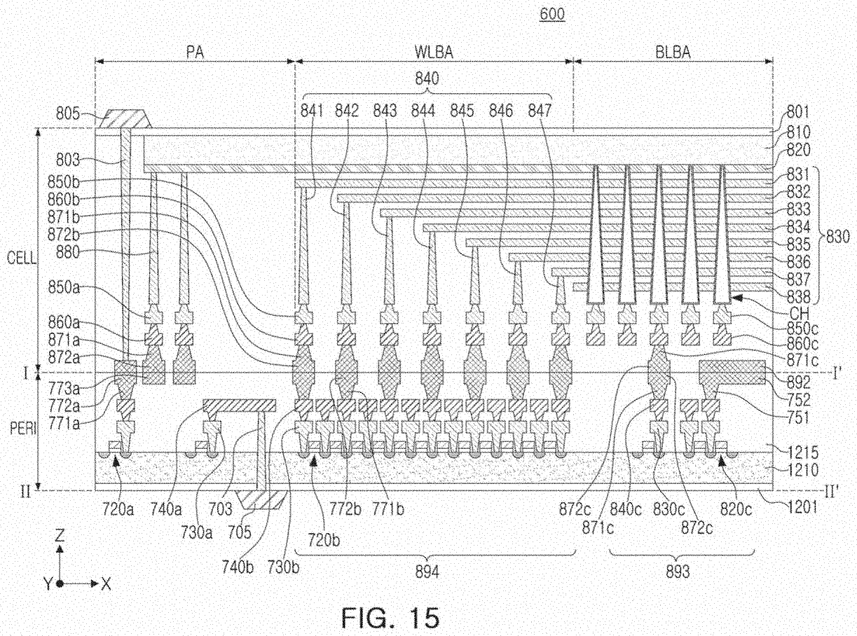

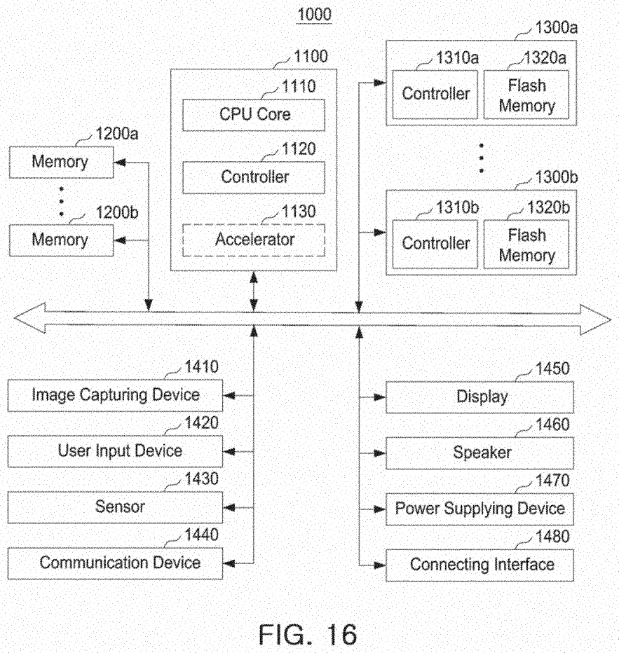

Hereinafter, a structure of a memory device to which the present inventive concepts may be applied and an example of a system to which the present inventive concepts may be applied will be described with reference to FIGS. 15 to 16.

FIG. 15 is a cross-sectional view illustrating a memory device according to some example embodiments.

Referring to FIG. 15, a memory device 600 may have a chip to chip (C2C) structure. The C2C structure may indicate a structure in which after fabricating an upper chip including a cell area CELL on a first wafer and fabricating a lower chip including a peripheral circuit area PERI on a second wafer different from the first wafer, the upper chip and the lower chip are connected to each other by bonding. For example, the bonding method may refer to a method of electrically connecting a bonding metal formed on an uppermost metal layer of the upper chip and a bonding metal formed on an uppermost metal layer of the lower chip to each other. For example, when the bonding metal is formed of copper (Cu), the bonding method may be a Cu—Cu bonding method, and the bonding metal may be formed of aluminum or tungsten.

Each of the peripheral circuit area PERI and the cell area CELL of the memory device 600 may include an external pad bonding area PA, a word line bonding area WLBA, and a bit line bonding area BLBA. The peripheral circuit area PERI may include a first substrate 710, an interlayer insulating layer 715, a plurality of circuit elements 720a, 720b and 720c formed on the first substrate 710, first metal layers 730a, 730b and 730c connected to the plurality of circuit elements 720a, 720b and 720c, respectively, and second metal layers 740a, 740b, and 740c formed on the first metal layers 730a, 730b, and 730c. In some example embodiments, the first metal layers 730a, 730b, and 730c may be formed of tungsten having a relatively high resistance, and the second metal layers 740a, 740b, and 740c may be formed of copper having a relatively low resistance.

In this specification, only the first metal layers 730a, 730b, 730c and the second metal layers 740a, 740b, and 740c are illustrated and described, but the present inventive concepts are not limited thereto, and at least one or more metal layers may be further formed on the second metal layers 740a, 740b, and 740c. At least a portion of the one or more metal layers formed on the second metal layers 740a, 740b, and 740c may be formed of aluminum having a lower resistance than that of copper forming the second metal layers 740a, 740b, and 740c.

The interlayer insulating layer 715 may be disposed on the first substrate 710 to cover the plurality of circuit elements 720a, 720b and 720c, the first metal layers 730a, 730b and 730c, and the second metal layers 740a, 740b and 740c, and may contain an insulating material such as silicon oxide, silicon nitride, or the like.

Lower bonding metals 771b and 772b may be formed on the second metal layer 740b of the word line bonding area WLBA. In the word line bonding area WLBA, the lower bonding metals 771b and 772b of the peripheral circuit area PERI may be electrically connected to the upper bonding metals 871b and 872b of the cell area CELL by a bonding method, and the lower bonding metals 771b and 772b and the upper bonding metals 871b and 872b may be formed of aluminum, copper, tungsten, or the like. The upper bonding metals 871b and 872b of the cell area CELL may be referred to as first metal pads, and the lower bonding metals 771b and 772b of the peripheral circuit area PERI may be referred to as second metal pads.

The cell area CELL may provide at least one memory block. The cell area CELL may include a second substrate 810 and a common source line 820. A plurality of word lines 831-838 (830) may be stacked on the second substrate 810 in a direction (Z-axis direction) perpendicular to the upper surface of the second substrate 810. String select lines and ground select lines may be disposed above and below the word lines 830, respectively, and a plurality of word lines 830 may be disposed between the string select lines and the ground select line.

In the bit line bonding area BLBA, a channel structure CH may extend in a direction perpendicular to the upper surface of the second substrate 810 and pass through the word lines 830, the string select lines, and the ground select line. The channel structure CH may include a data storage layer, a channel layer, and a buried insulating layer, and the channel layer may be electrically connected to a first metal layer 850c and a second metal layer 860c. For example, the first metal layer 850c may be a bit line contact, and the second metal layer 860c may be a bit line. In some example embodiments, the bit line may extend in a first direction (Y-axis direction) parallel to the upper surface of the second substrate 810.

In some example embodiments illustrated in FIG. 15, an area in which the channel structure CH and the bit line are disposed may be defined as the bit line bonding area BLBA. The bit line may be electrically connected to the circuit elements 720c providing the page buffer 893 in the peripheral circuit area PERI in the bit line bonding area BLBA. As an example, the bit line may be connected to the upper bonding metals 871c and 872c in the peripheral circuit area PERI, and the upper bonding metals 871c and 872c may be connected to the lower bonding metals 771c and 772c connected to the circuit elements 720c of the page buffer 893.

In the word line bonding area WLBA, the word lines 830 may extend in a second direction (X-axis direction) parallel to the upper surface of the second substrate 810, and include a plurality of cell contact plugs 841-847 (840). The word lines 830 and the cell contact plugs 840 may be connected to each other through pads provided by at least some of the word lines 830 extending to different lengths in the second direction (X-axis direction). A first metal layer 850b and a second metal layer 860b may be sequentially connected to the upper portions of the cell contact plugs 840 connected to the word lines 830. In the word line bonding area WLBA, the cell contact plugs 840 may be connected to the peripheral circuit area PERI through the upper bonding metals 871b and 872b of the cell area CELL and the lower bonding metals 771b and 772b of the peripheral circuit area PERI.

The cell contact plugs 840 may be electrically connected to circuit elements 720b providing the row decoder 894 in the peripheral circuit area PERI. In some example embodiments, the operating voltages of the circuit elements 720b providing the row decoder 894 may be different from the operating voltages of the circuit elements 720c providing the page buffer 893. For example, the operating voltages of the circuit elements 720c providing the page buffer 893 may be greater than the operating voltages of the circuit elements 720b providing the row decoder 894.

A common source line contact plug 880 may be disposed in the external pad bonding area PA. The common source line contact plug 880 may be formed of a conductive material such as metal, a metal compound, polysilicon or the like, and may be electrically connected to the common source line 820. A first metal layer 850a and a second metal layer 860a may be sequentially stacked on the common source line contact plug 880. For example, the region in which the common source line contact plug 880, the first metal layer 850a, and the second metal layer 860a are disposed may be defined as the external pad bonding area PA.

On the other hand, input/output pads 705 and 805 may be disposed in the external pad bonding area PA. Referring to FIG. 15, a lower insulating layer 701 covering the lower surface of the first substrate 710 may be formed below the first substrate 710, and first input/output pads 705 may be formed on the lower insulating layer 701. The first input/output pad 705 may be connected to at least one of the plurality of circuit elements 720a, 720b, and 720c disposed in the peripheral circuit area PERI, through the first input/output contact plug 703, and may be separated from the first substrate 710 by the lower insulating layer 701. In addition, a side insulating layer is disposed between the first input/output contact plug 703 and the first substrate 710 to electrically separate the first input/output contact plug 703 from the first substrate 710.

Referring to FIG. 15, an upper insulating layer 801 covering the upper surface of the second substrate 810 may be formed on the second substrate 810, and a second input/output pad 805 may be disposed on the upper insulating layer 801. The second input/output pad 805 may be connected to at least one of the plurality of circuit elements 720a, 720b, and 720c disposed in the peripheral circuit area PERI through the second input/output contact plug 803.

In some example embodiments, the second substrate 810 and the common source line 820 may not be disposed in the region in which the second input/output contact plug 803 is disposed. Also, the second input/output pad 805 may not overlap the word lines 830 in the third direction (Z-axis direction). Referring to FIG. 15, the second input/output contact plug 803 may be separated from the second substrate 810 in a direction parallel to the upper surface of the second substrate 810, and may be connected to the second input/output pad 805 by penetrating through the interlayer insulating layer 815 of the cell area CELL.

In some example embodiments, the first input/output pad 705 and the second input/output pad 805 may be selectively formed. For example, the memory device 600 includes only the first input/output pad 705 disposed on the first substrate 710, or may only include the second input/output pad 805 disposed on the second substrate 810. Alternatively, the memory device 600 may include both the first input/output pad 705 and the second input/output pad 805.

In each of the external pad bonding area PA and the bit line bonding area BLBA included in each of the cell area CELL and the peripheral circuit area PERI, the metal pattern of the uppermost metal layer may exist as a dummy pattern, or the uppermost metal layer may be empty.

In the case of the memory device 600, in the external pad bonding area PA, a lower metal pattern 773a having the same shape as the upper metal pattern 872a of the cell area CELL may be formed on the uppermost metal layer of the peripheral circuit area PERI, to correspond to the upper metal pattern 872a formed on the uppermost metal layer of the cell area CELL. The lower metal pattern 773a formed on the uppermost metal layer of the peripheral circuit area PERI may not be connected to a separate contact in the peripheral circuit area PERI. Similarly, an upper metal pattern having the same shape as the lower metal pattern of the peripheral circuit area PERI may be formed on the upper metal layer of the cell area CELL, to correspond to the lower metal pattern formed in the uppermost metal layer of the peripheral circuit area PERI, in the external pad bonding area PA.

The lower bonding metals 771b and 772b may be formed on the second metal layer 740b of the word line bonding area WLBA. In the word line bonding area WLBA, the lower bonding metals 771b and 772b of the peripheral circuit area PERI may be electrically connected to the upper bonding metals 871b and 872b of the cell area CELL by a bonding method.

In addition, in the bit line bonding area BLBA, an upper metal pattern 892 having the same shape as the lower metal pattern 752 of the peripheral circuit area PERI may be formed on the uppermost metal layer of the cell area CELL, to correspond to the lower metal pattern 752 formed on the uppermost metal layer of the peripheral circuit area PERI. In some example embodiments, a contact may not be formed on the upper metal pattern 892 formed on the uppermost metal layer of the cell area CELL.

In some example embodiments, corresponding to the metal pattern formed on the uppermost metal layer of one of the cell area CELL and the peripheral circuit area PERI, a reinforced metal pattern having the same cross-sectional shape as the formed metal pattern may be formed on the uppermost metal layer of the other one of the cell area CELL and the peripheral circuit area PERI. A contact may not be formed on the reinforced metal pattern.

The memory device 600 may include memory regions having different bit densities according to the number of bits stored in the memory cells. According to some example embodiments, data may be divided and stored in memory regions having different bit densities according to attributes. A classification criterion for dividing and storing data may be dynamically adjusted according to the degree of wear of the memory regions, and as a result, the memory regions may be evenly worn and the lifespan of the memory device 600 may be improved.

FIG. 16 is a diagram illustrating a system 1000 to which a storage device according to some example embodiments is applied. The system 1000 of FIG. 16 may basically be a mobile system such as a mobile phone, a smart phone, a tablet personal computer, a wearable device, a healthcare device, or an Internet of things (IOT) device. However, the system 1000 of FIG. 16 is not necessarily limited to a mobile system, and may also be an automotive device such as navigation, a personal computer, a laptop computer, a server, a media player, or the like.

Referring to FIG. 16, the system 1000 may include a main processor 1100, memories 1200a and 1200b, and storage devices 1300a and 1300b, and additionally, may include one or more of an image capturing device 1410, a user input device 1420, a sensor 1430, a communication device 1440, a display 1450, a speaker 1460, a power supplying device 1470, and a connecting interface 1480.

The main processor 1100 may control the overall operation of the system 1000, and in detail, the operation of other components constituting the system 1000. The main processor 1100 may be implemented as a general-purpose processor, a dedicated processor, or an application processor.

The main processor 1100 may include one or more CPU cores 1110 and may further include a controller 1120 for controlling the memories 1200a and 1200b and/or the storage devices 1300a and 1300b. According to some example embodiments, the main processor 1100 may further include an accelerator 1130 that is a dedicated circuit for high-speed data operation such as artificial intelligence (AI) data operation. The accelerator 1130 may include a graphics processing unit (GPU), a neural processing unit (NPU), and/or a data processing unit (DPU), and may be implemented as a separate chip physically independent from other components of the main processor 1100.

The memories 1200a and 1200b may be used as the main memory device of the system 1000 and may include volatile memories such as SRAM and/or DRAM, and may also include non-volatile memories such as flash memory, PRAM and/or RRAM. The memories 1200a and 1200b may be implemented in the same package as the main processor 1100.

The storage devices 1300a and 1300b may function as nonvolatile storage devices that store data regardless of whether power is supplied or not, and may have a relatively larger storage capacity than the memories 1200a and 1200b. The storage devices 1300a and 1300b may include storage controllers 1310a and 1310b and non-volatile memory (NVM) 1320a and 1320b for storing data under the control of the storage controllers 1310a and 1310b. The nonvolatile memories 1320a and 1320b may include a flash memory having a 2D (2-dimensional) structure or a 3D (3-dimensional) V-NAND (Vertical NAND) structure, but may also include other types of non-volatile memory such as PRAM and/or RRAM.

The storage devices 1300a and 1300b may be included in the system 1000 in a state physically separated from the main processor 1100, or may be implemented in the same package as the main processor 1100. In addition, the storage devices 1300a and 1300b may have the same shape as a solid state device (SSD) or a memory card, and may be detachably coupled to other components of the system 1000 through an interface such as a connecting interface 1480 to be described later. The storage devices 1300a and 1300b may be devices to which standard protocols such as Universal Flash Storage (UFS), embedded multi-media card (eMMC), or non-volatile memory express (NVMe) are applied, but are not necessarily limited thereto.

The storage devices 1300a and 1300b according to some example embodiments may include memory regions having different bit densities. The storage devices 1300a and 1300b may classify data according to the hotness of the data and store the classified data separately in the memory regions. The storage devices 1300a and 1300b dynamically adjust the data classification criteria according to the degree of wear of the memory regions, thereby mitigating uneven wear of the memory regions and improving the lifespan of the memory regions.

The image capturing device 1410 may capture a still image or a moving image, and may be a camera, a camcorder, and/or a webcam.

The user input device 1420 may receive various types of data input from a user of the system 1000, and may be a touch pad, a keypad, a keyboard, a mouse, and/or a microphone.

The sensor 1430 may detect various types of physical quantities that may be obtained from the outside of the system 1000, and may convert the sensed physical quantities into electrical signals. The sensor 1430 may be a temperature sensor, a pressure sensor, an illuminance sensor, a position sensor, an acceleration sensor, a biosensor and/or a gyroscope sensor.

The communication device 1440 may transmit and receive signals between other devices outside the system 1000 according to various communication protocols. The communication device 1440 may be implemented including an antenna, a transceiver, and/or a modem.

The display 1450 and the speaker 1460 may function as output devices for outputting visual information and auditory information to the user of the system 1000, respectively.

The power supplying device 1470 may appropriately convert power supplied from a battery (not illustrated) embedded in the system 1000 and/or an external power source and supply the power to respective components of the system 1000.

The connecting interface 1480 may provide a connection between the system 1000 and an external device connected to the system 1000 to exchange data with the system 1000. The connecting interface 1480 may be implemented in various interface methods such as Advanced Technology Attachment (ATA), Serial ATA (SATA), external SATA (e-SATA), Small Computer Small Interface (SCSI), Serial Attached SCSI (SAS), Peripheral Component Interconnection (PCI), PCI express (PCIe), NVMe, IEEE 1394, universal serial bus (USB), secure digital (SD) card, multi-media card (MMC), eMMC, UFS, embedded Universal Flash Storage (eUFS), compact flash (CF) card interface, or the like.

As set forth above, according to example embodiments, configurations and operations related to a storage device separately storing hot data and cold data in memory regions having different bit densities may be provided.

According to example embodiments, a storage device in which memory regions are evenly worn out by adjusting a criterion for dividing hot data and cold data based on the degree

of wear of each of the memory regions may be provided. According to example embodiments, a storage device of which lifespan may be improved by uniform wear-out of memory regions may be provided.

The storage device 200 (or other circuitry, for example, the storage controller 210, host 100, CPU 213, FTL 214, Packet Manager 215, buffer memory 216, ECC 217, AES 218, memory device 300, control logic 320, page buffer 340, separator 231, address allocator 232, block manager 233, storage device 500 (and components) system 1000 (and components) or other circuitry discussed herein) may include hardware including logic circuits; a hardware/software combination such as a processor executing software; or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc.

While example embodiments have been illustrated and described above, it will be apparent to those skilled in the art that modifications and variations could be made without departing from the scope of the present inventive concepts as defined by the appended claims.

What is claimed is:

1. A method of operating a storage device including a first memory region having a lowest bit density, a second memory region having a medium bit density, and a third memory region having a highest bit density, the method comprising:
determining a hotness of a logical address received with a write command and data to be written, from a host;
based on the determined hotness being greater than a first hotness threshold, determining whether a wear level of the first memory region is greater than a wear threshold; and
increasing the first hotness threshold and storing the data in the second memory region based on the wear level of the first memory region being greater than the wear threshold.

2. The method of claim 1, further comprising determining the wear level of the first memory region, based on a current Program/Erase (P/E) cycle and a limit P/E cycle of memory blocks included in the first memory region.

3. The method of claim 1, further comprising determining the wear threshold based on an average wear level of the first to third memory regions.

4. The method of claim 1, further comprising storing the data in the first memory region based on the wear level of the first memory region being less than or equal to the wear threshold.

5. The method of claim 1, further comprising:
determining, based on the determined hotness being less than or equal to the first hotness threshold and greater than a second hotness threshold, whether a wear level of the second memory region is greater than the wear threshold; and
lowering the first hotness threshold, increasing the second hotness threshold, and storing the data in the third memory region, based on the wear level of the second memory region being greater than the wear threshold.

6. The method of claim 5, further comprising storing the data in the second memory region based on the wear level of the second memory region being less than or equal to the wear threshold.

7. The method of claim 1, further comprising:
determining, based on the determined hotness being less than or equal to a second hotness threshold, whether a wear level of the third memory region is greater than the wear threshold; and
lowering the second hotness threshold and storing the data in the second memory region based on the wear level of the third memory region being greater than the wear threshold.

8. The method of claim 7, further comprising storing the data in the third memory region based on the wear level of the third memory region being less than or equal to the wear threshold.

9. The method of claim 1, wherein
the first memory region includes single level cell (SLC) memory blocks,
the second memory region includes triple level cell (TLC) memory blocks, and
the third memory region includes quadruple level cell (QLC) memory blocks.

10. A storage device comprising:
a memory device including memory regions having different bit densities; and
a controller controlling the memory device,
wherein the controller is configured to determine hotness of data received from a host,
determine a target memory region to store the data from among the memory regions according to whether the hotness exceeds a hotness threshold,
change the hotness threshold according to a wear level of the target memory region,
change the target memory region, and
store the data in the changed target memory region.

11. The storage device of claim 10, wherein the controller is configured to change the hotness threshold to reduce an amount of the data stored in the target memory region from among the data received from the host, based on the wear level of the target memory region is greater than a wear threshold.

12. The storage device of claim 11, wherein
the memory regions include a first memory region and a second memory region having a bit density higher than a bit density of the first memory region, and
the controller is configured to determine the first memory region as the target memory region based on the hotness being greater than the hotness threshold, and increase the hotness threshold based on a wear level of the first memory region being greater than the wear threshold, to reduce an amount of data stored in the first memory region.

13. The storage device of claim 12, wherein the controller is configured to determine the second memory region as the target memory region based on the hotness being less than or equal to the hotness threshold, and lower the hotness threshold based on a wear level of the second memory region being greater than the wear threshold, to reduce an amount of data stored in the second memory region.

14. The storage device of claim 11, wherein the controller is configured to determine the wear threshold based on an average wear level of the memory regions.

15. The storage device of claim 14, wherein the controller is configured to determine the average wear level based on a current P/E cycle and a limit P/E cycle of the memory regions.

16. The storage device of claim 10, wherein the controller is configured to
insert a latest logical address received from a host together with the data into a logical address list,
give a maximum weight to the latest logical address,
reduce a weight of existing logical addresses stored in the logical address list, and
sum weights of logical addresses having the same value as the latest logical address to determine the hotness of the data.

17. A controller for controlling a memory device including memory regions having different bit densities, the controller comprising:
a memory configured to store wearout information of the memory regions; and
a processor configured to
adjust a hotness threshold, a criterion for classifying and storing data in the memory regions according to hotness of data, based on a wear imbalance between the memory regions being detected based on the wearout information,
determine hotness of data received from a host, and
provide the data to a selected memory region among the memory regions according to whether the hotness exceeds the hotness threshold.

18. The controller of claim 17, wherein the processor is configured to change the hotness threshold to reduce an amount of data provided to a memory region having a wear level higher than an average wear level of the memory regions.

19. The controller of claim 17, wherein the memory is further configured to store a logical address list including logical addresses lately received from the host, and
the processor is further configured to
insert a latest logical address received together with data from the host into
the logical address list,
give the latest logical address a maximum weight,
reduce a weight of existing logical addresses, and
sum weights of logical addresses having the same value as the latest logical address to determine hotness of the latest logical address.

20. The controller of claim 17, wherein the processor is configured to determine a sector size received together with data from the host as the hotness of the data, and determine the data as hot data based on the hotness of the data being less than or equal to the hotness threshold.
